(19) United States
(12) Patent Application Publication
(10) Pub. No.: US 2008/0193081 A1
(43) Pub. Date: Aug. 14, 2008

(54) Microscope

(75) Inventors: William C. HAY, Heppenheim (DE); Heinrich ULRICH, Heidelberg (DE)

Correspondence Address: CROWELL & MORING LLP;INTELLECTUAL PROPERTY GROUP, P.O. BOX 14300, WASHINGTON, DC, 20044-4300, US

(73) Assignee: Leica Microsystems CMS GmbH, Wetzlar (DE)

(21) Appl. No.: 12/029,854

(22) Filed: Feb. 12, 2008

(30) Foreign Application Priority Data
Feb. 13, 2007 (DE) 10 2007 007 655.1

(51) Int. Cl. G02B 6/26

(52) U.S. Cl. 385/31

(57) ABSTRACT

A microscope, in particular a laser scanning microscope, with an illuminating light source includes a device for combining a number of individual laser light beams into one common optical fiber. The combining device is designed and developed in order to combine beams reliably and simply even if the operating period of the microscope is long. The device for forming the common optical fiber has optical fibers which are assigned to individual laser light beams, that are connected to one another by being fused-together.

### CROSS-REFERENCE TO RELATED APPLICATION

This application claims the priority of German Application No. 10 2007 007 655.1, filed Feb. 13, 2007, the disclosure of which is expressly incorporated by reference herein.

### BACKGROUND AND SUMMARY OF THE INVENTION

The present invention relates to a microscope and, in particular, to a laser scanning microscope, with an illuminating light source having a device for combining a number of individual laser light beams into one common optical fiber.

microscope of the type mentioned above is known, for example, from DE 196 33 185 A1. In concrete terms, DE 196 33 185 A1 discloses a laser scanning microscope with an illuminating light source having a beam combiner for combining four individual laser light beams into one common optical fiber. In the beam combiner, the beams are combined via dichroic beam combiners. Microscopes in which a number of individual laser light beams are combined into one common optical fiber are advantageous in applications where a number of different wavelengths or laser lines are needed at the same time.

One problem in the known microscope is the fact that a large adjustment outlay with respect to reliably coupling the individual laser light beams into the common optical fiber is needed for superposing the individual beams. Furthermore, an extremely high-quality mechanical design of the device is necessary in order to maintain a stable position of the splitter mirrors of the dichroic beam combiner if the microscope is in operation for a long time.

The present invention therefore provides a microscope of the above-mentioned type, in which beams can be combined reliably and simply even if the operating period is long.

According to the present invention, the microscope is designed and developed such that the device—for forming the common optical fiber—has optical fibers which are assigned to the individual laser light beams and are connected to one another by being fused-together.

It has been found in an inventive manner that by suitably connecting optical fibers, which are assigned to the individual laser light beams, the beams can be combined reliably and simply even for a long operating period in a surprisingly simple manner. In particular, the optical fibers, which are assigned to the individual laser light beams, are connected to one another by fusing-together, so that individual optical fibers merge into the common optical fiber. In the case of two laser light beams to be combined, for example, two optical fibers would be fused together such that two optical fibers merge into one optical fiber. In the case of three laser light beams to be combined, for example, a third optical fiber, which is assigned to the third laser light beam, can be fused to the common optical fiber of the first two laser light beams. As a result, three optical fibers then merge into one common optical fiber, and three different laser light beams can be combined into this common optical fiber.

In the microscope according to the invention, a high adjustment outlay is no longer necessary to combine the laser light beams. All that is needed is to ensure that the laser light beams are coupled into the assigned optical fibers. The device can have a relatively simple design in this case, where attention need only be paid to a reliable fusing-together of the individual optical fibers into one common optical fiber.

Consequently, the microscope according to the invention is a microscope in which beams can be combined reliably and simply even if the operating period is long.

In particular, the device could have at least two light inputs and one light output. The number of light inputs depends on the number of laser light beams to be combined. One light input is provided for each individual laser light beam.

In order to provide particularly simple and reliable coupling of the laser light beam or of an optical fiber arranged between a laser light source and the device, the light inputs could have a fiber-optic connector. In this case, it is merely necessary to couple the optical fiber, which is coupled to the respective laser light source, to the fiber-optic connector.

In an alternative embodiment, the light inputs could have a connector for a fiber pigtail.

In another advantageous embodiment, the light output could have a fiber-optic connector or a fiber pigtail. The connection which is appropriate in each case can be made between the device and further components in the beam path of the microscope depending on the requirements.

In another advantageous manner, a fiber-optic connector or a connector for a fiber pigtail could also be provided on the laser light source of the individual laser light beams. To this extent, an optical fiber could simply be arranged between an individual laser light source and the device.

In a further embodiment of the microscope, the optical fibers could be single-mode optical fibers.

With respect to a particularly large versatility of the microscope, at least one optical component for influencing the combined laser light beam could be arranged in a beam path downstream of the device. Such a component could be in the form of a modulator for wavelength selection, for example. A modulator of this type could, in a particularly convenient manner, be in the form of an AOTF (Acousto-Optical Tunable Filter). A modulator of this type could be used to accurately select that wavelength from the combined light beam which is necessary for the desired application.

In an embodiment of the microscope which is likewise particularly convenient, at least one optical component for influencing or selecting the wavelength of an individual laser light beam could be arranged in a beam path upstream of the device. In this case, the component could also be in the form of a modulator, preferably an AOTF. In this manner, it would be possible for a light beam which is guided into the device to be defined exactly.

In order to subject an individual optical fiber to as low an optical load as possible, a mechanical or electric shutter could be arranged between a laser light source, which produces an individual laser light beam, and the device. Individual optical fibers could in this case be conserved if individual laser light beams are not needed depending on the desired application.

In a particularly advantageous manner, the shutter could be arranged at the output of the laser light source. This completely prevents radiation from entering the subsequent optical fiber.

For a particularly compact design of the microscope, the shutter could be integrated in a plug connector at the output.

The microscope according to the invention permits different discrete laser light sources to be combined to form one single light source. This can achieve high stability and a simple design, in particular by being able to plug-connect the individual lasers via fiber-optic connectors. A modulator connected downstream enables a wavelength selection.

There are now various possible ways of implementing and developing the teaching of the present invention in an advantageous manner. Reference is made here to the following description of an exemplary embodiment of the microscope according to the invention using the drawings. Generally preferred embodiments and developments of the teaching will also be described in connection with the description of the preferred exemplary embodiment of the microscope according to the invention using the drawings.

### BRIEF DESCRIPTION OF THE DRAWINGS

FIG. 1 is a partial schematic view of an exemplary embodiment of a microscope according to the invention; and

FIG. 2 is a schematic diagram of the path of optical fibers inside the device for combining a number of individual laser light beams into one common optical fiber.

### DETAILED DESCRIPTION OF THE DRAWINGS

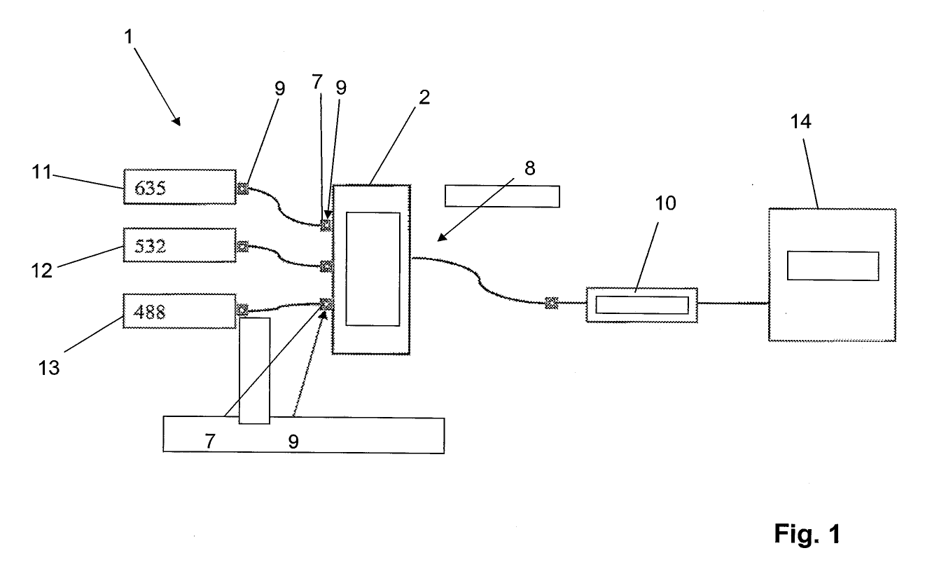

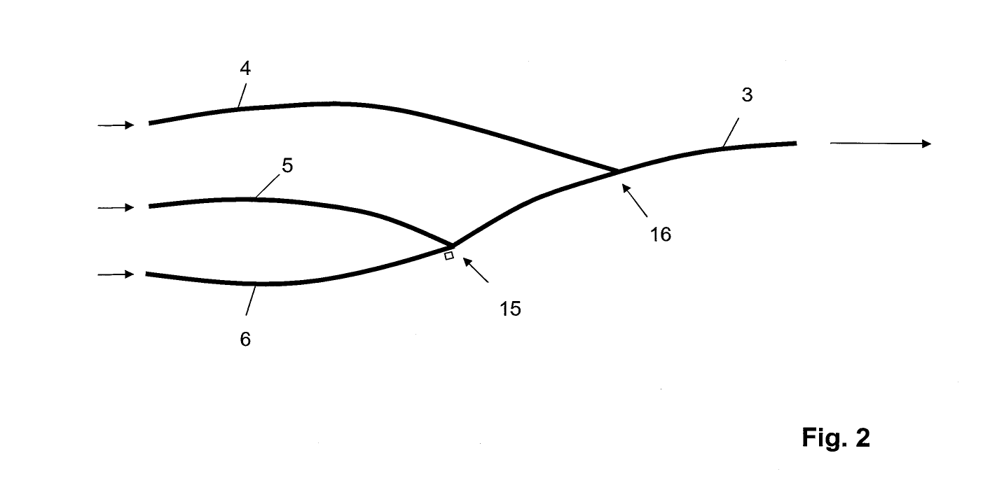

FIG. 1 shows partially, in a schematic view, an exemplary embodiment of a microscope according to the invention. The exemplary embodiment is a laser scanning microscope 1 with an illuminating light source having a device 2 for combining a number of individual laser light beams into one common optical fiber 3. In order to combine beams in a particularly reliable manner even if the operating period is long, the device 2—for forming the common optical fiber 3—has optical fibers 4, 5 and 6 (shown schematically in detail in FIG. 2) which are assigned to the individual laser light beams and are connected to one another by being fused-together.

The device 2 has three light inputs 7 and one light output 8, so that laser light beams with three different wavelengths can be combined into the common optical fiber 3.

In order to provide particularly simple coupling of the laser light beams or of assigned optical fibers, the light inputs 7 have a fiber-optic connector 9. The laser light beams could, however, also be coupled using a fiber pigtail.

Connected downstream of the device 2 in the beam path is a modulator 10, which is used for wavelength selection with respect to the combined laser light beams depending on the desired application.

The laser light beams produced in the exemplary embodiment shown here are produced using laser light sources 11, 12 and 13 having laser light with the wavelengths 635 nm, 532 nm and 488 nm. Fiber-optic connectors 9 are likewise arranged on the respective outputs of the laser light sources 11, 12 and 13 for coupling optical fibers to the laser light sources 11, 12 and 13. Thus, optical fibers can be coupled to the device 2 and to the laser light sources 11, 12 and 13 in a particularly simple manner.

Finally, the combined laser light beam is guided to a scanning device 14.

FIG. 2 shows the fusing-together of the optical fibers 5 and 6 at a fusion point 15 and a fusing-together of the optical fiber 4 with the optical fiber which is formed from the optical fibers 5 and 6 at a fusion point 16. As a result, one common optical fiber 3, which has laser light with three different wavelengths, is formed.

With respect to further advantageous embodiments of the micoroscope according to the invention and in order to avoid repetitions, reference is made to the general description and to the claims.

Finally, express mention is made of the fact that the previously described exemplary embodiment of the microscope according to the invention merely serves for discussing the claimed teaching, but does not limit it to the exemplary embodiment.

### TABLE OF REFERENCE SYMBOLS

1 illuminating light source
2 device
3 optical fiber
4 optical fiber
5 optical fiber
6 optical fiber
7 light input
8 light output
9 fiber-optic connector
10 modulator
11 laser light source
12 laser light source
13 laser light source
14 scanning device
15 fusion point
16 fusion point

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A microscope, comprising:
an illuminating light source;
a device for combining a number of individual laser light beams into one common optical fiber; and
wherein the device for combining the number of individual laser light beams into the one common optical fiber comprises optical fibers respectively assigned to individual laser light beams and having a fused together connection to one another.

2. The microscope according to claim 1, wherein the device for combining comprises at least two light inputs and one light output.

3. The microscope according to claim 2, wherein at least one of the at least two light inputs has a fiber-optic connector.

4. The microscope according to claim 2, wherein at least one of the at least two light inputs has a connector for a fiber pigtail.

5. The microscope according to claim 3, wherein at least one of the at least two light inputs has a connector for a fiber pigtail.

6. The microscope according to claim 2, wherein the light output has one of a fiber-optic connector and a fiber pigtail.

7. The microscope according to claim 3, wherein the light output has one of a fiber-optic connector and a fiber pigtail.

8. The microscope according to claim 5, wherein the light output has one of a fiber-optic connector and a fiber pigtail.

9. The microscope according to claim 1, wherein the optical fibers are single-mode optical fibers.

10. The microscope according to claim 1, further comprising at least one optical component arranged in a beam path downstream of the device for combining, the at least one optical component influencing the combined laser light beam.

11. The microscope according to claim 1, further comprising at least one optical component arranged in a beam path upstream of the device for combining, the at least one optical component influencing or selecting a wavelength of an individual laser light beam.

12. The microscope according to claim 10, further comprising at least one optical component arranged in a beam path upstream of the device for combining, the at least one optical component influencing or selecting a wavelength of an individual laser light beam.

13. The microscope according to claim 10, wherein the at least one optical component is an AOTF.

14. The microscope according to claim 11, wherein the at least one optical component is an AOTF.

15. The microscope according to claim 1, further comprising a shutter arranged between a laser light source for producing an individual laser light beam and the device for combining.

16. The microscope according to claim 15, wherein the shutter is arranged at an output of the laser light source.

17. The microscope according to claim 15, wherein the shutter is integrated in a plug connector at an output of the laser light source.

18. The microscope according to claim 1, wherein the microscope is a laser scanning microscope.

19. A method of manufacturing a laser scanning microscope having a plurality of laser light sources, each laser light source producing an individual laser light beam, the method comprising the acts of:
providing an individual optical fiber for each individual laser light beam produced from one of the plurality of light sources;
fusing together at least two of the individual optical fibers into one common optical fiber; and
providing the one common optical fiber to a scanning system of the laser scanning microscope.

20. The method according to claim 19, wherein at least three optical fibers assigned to individual laser light sources are provided, the fusing act further comprising the acts of:
fusing-together the third optical fiber assigned to a third laser light beam to the one common optical fiber produced by the fusing-together of the at least two optical fibers, whereby the at least three optical fibers are merged into one common optical fiber.
